(19) United States
(12) Patent Application Publication
(10) Pub. No.: US 2006/0067689 A1
(43) Pub. Date: Mar. 30, 2006

(54) Method, system & apparatus for managing a data burst throughput of an optical burst switching (OBS) network

(75) Inventor: Miguel De Vega Rodrigo, Brussels (BE)

Correspondence Address: SIEMENS CORPORATION;INTELLECTUAL PROPERTY DEPARTMENT, 170 WOOD AVENUE, SOUTH, ISELIN, NJ, 08830, US

(73) Assignee: SIEMENS AKTIENGESELLSCHAFT

(21) Appl. No.: 11/239,409

(22) Filed: Sep. 29, 2005

(30) Foreign Application Priority Data
Sep. 30, 2004 (EP) 04023352.0

(51) Int. Cl. H04J 14/00

(52) U.S. Cl. 398/49

(57) ABSTRACT

Managing a data burst throughput of an Optical Burst Switching (OBS) network (100). A setup time is determined based on a probability (Pi) that a burst at a core node (102) of the OBS network (100) was sent by an edge node (104a, 104b) coupled to the core node (102). An effective wavelength utilization (ρ_{λ}) is determined based on the set up time. The blocking probability (P) for the core node (102) is determined based on the effective wavelength utilization (ρ_{λ}).

### CROSS REFERENCE TO RELATED APPLICATIONS

This application claims priority to the European application No. 04023352.0, filed Sep. 30, 2004 and which is incorporated by reference herein in its entirety.

### FIELD OF INVENTION

The invention relates to optical networks comprising a number of interconnected nodes, where information is transmitted in bursts of data packets between the nodes along pathways.

### SUMMARY OF THE INVENTION

A key measure of performance in optical networks, particularly, dynamic wavelength routed optical networks, is the blocking probability, or the probability that an incoming connection request will be denied. One source of connection blocking is insufficient network resources. If a route with sufficient capacity cannot be found between the source node and destination node, then the connection request must be blocked. Furthermore, if there are no wavelength converters in the network, then the lightpath for the connection must utilize the same wavelength on each link in the path between the source node and the destination node. If no such wavelength is available, then the connection will be blocked, even if capacity is available.

It is expected that, as network traffic continues to scale up and become more bursty in nature, a higher degree of multiplexing and flexibility will be required at the optical layer. Thus, lightpath establishment will become more dynamic in nature, with connection requests arriving at higher rates, and lightpaths being established for shorter time durations. In such situations, blocking due to conflicting connection requests may become an increasingly significant component of the overall connection blocking probability.

The blocking probability is, thus, perhaps the most important performance parameter for OBS (Optical Burst Switching) networks, since it determines the network throughput. It is therefore very important for the design and management of OBS networks to have a method to calculate the blocking probability at each optical fiber of the OBS network.

Blocking probability in wavelength-routed optical networks has been studied analytically in a number of previous works. See, for example, A. Birman, “Computing Approximate Blocking Probabilities for a Class of All-Optical Networks,” IEEE Journal on Selected Areas in Communications, vol. 14, no. 5, pp. 852-857, June 1996; R. A. Barry and P. A. Humblet, “Models of Blocking Probability in All-Optical Networks with and Without Wavelength Changers,” IEEE Journalon Selected Areas in Communications, vol. 14, no. 5, pp. 858-867, June 1996; or A. Mokhtar and M. Azizoglu, “Adaptive Wavelength Routing in All- Optical Networks,” IEEE/ACMTransactions on Networking vol. 6, no. 2, pp. 197-206, April 1998.

Another well-known formula for calculating the blocking probability is known as the Erlang B formula. In particular, the Erlang B formula is applicable to networks that are described in terms of a Poisson Arrival Process, the inter-arrival time between consecutive data packet arrivals is exponentially distributed. The Erlang B formula is widely known throughout the literature and will not be discussed here in detail.

Problematically, all of the foregoing methods assume that the entire bandwidth of the optical fiber is available to burst transmissions. On the other hand, it is widely known that, due to technological limitations, the optical switches along the burst path must be configured and some signalling information must be processed at the electrical domain in order to send a burst. This takes a time that is in most cases non negligible. During this time, that we shall call the setup time, no information can be sent through the wavelength, that is, it is a dead time. Consequently, not all of the bandwidth of a wavelength is available for burst transmissions. Intuitively seen, this time grows with the frequency of burst transmissions and with the size of the setup time (influenced by technological factors).

The reduction of the available bandwidth due to the setup time increases inevitably the blocking probability. With non-negligible setup times there is likely a big difference between the results provided by the traditional methods and the blocking probabilities measured in a real OBS network. What is lacking in the art is a method, system and apparatus to calculate the blocking probability incorporating the setup times.

The main idea of the invention is to calculate the blocking probability based on the setup times owing to the edge nodes. In order to carry this out, the invention introduces and calculates a new concept called the effective bandwidth. The effective bandwidth is defined here as the link capacity that is left after removing the setup times for the transmission of each burst. Therefore, the effective bandwidth is a measure of the link capacity which can be really used to transfer information. Based on this, the invention then calculates the effective wavelength utilization, defined herein as the percentage of wavelength bandwidth that is being used to transfer bursts relative to the total wavelength bandwidth that can be used for burst transmissions (i.e. removing the setup times). Based on the average effective wavelength utilization, a general method that calculates the blocking probability at each link of an OBS network is provided.

According to the invention there is provided, in one embodiment, a method for managing a data burst throughput of an Optical Burst Switching (OBS) network (100). A setup time is determined based on a probability (Pi) that a burst at a core node (102) of the OBS network (100) was sent by an edge node (104a, 104b) coupled to the core node (102). An effective wavelength utilization (ρ_{λ}) is determined based on the set up time. The blocking probability (P) for the core node (102) is determined based on the effective wavelength utilization (ρ_{λ}) and the data burst is routed using the blocking probability.

The effective wavelength utilization (ρ_{λ}) may be determined according to the following equation

$${ρ}_{λ} = \frac{1}{{C}_{λ} \cdot {N}_{λ} \cdot [ \frac{1}{b} - \frac{{t}_{setup}}{B} ]}$$

wherein C_{λ} is the wavelength capacity of the core node 102, N_{λ} is the number of wavelengths of the core node 102, b is the total average throughput at an ingress of the core node 102, tₛₑₜᵤₚ is the average setup time corresponding to the edge node 104a, 104b, etc., and B is the average burst size of the core node 102.

There is also provided a system and apparatus for managing a data burst throughput of an Optical Burst Switching (OBS) network (100), including a core node (102) of the OBS network and one or more edge nodes (104a, 104b) connected to the core node (102). The core node 102 is allocated a wavelength based on a blocking probability that is determined using at least the setup time of the one or more edge nodes (104a, 104b).

Exemplary, the invention may be utilized as a method and has several applications. For instance, the invention could be used in a planning tool, in order to design OBS networks that fulfil a certain maximum allowed blocking probability. It could also be used in OBS edge nodes 104a, 104b, etc. as the core of an Admission Control mechanism that accepts or rejects bursts depending on whether the additional load makes the average blocking probability (or average network throughput) exceed (or lower) a certain limit. It could be used to help a routing algorithm to balance the load, so that all end-to-end paths have approximately the same average blocking probability or throughput. It could be used to help a QoS routing algorithm to route high-priority bursts through lower blocking probability paths.

The invention has a wide variety of applications including, but not limited to, telephone networks, computer networks, optical networks (e.g., optical burst switching network) wireless networks production lines and manufacturing systems and traffic classes. The term “network” as described hereinafter should be interpreted as such. In general the network comprises a number of interconnected nodes (these may be e.g., processors in a telecommunication system), where information flows between the nodes by links, e.g., in packets along wires. The term “pathway” comprises several network nodes joined by links.

The several figures illustrate at least one example of the invention.

### BRIEF DESCRIPTION OF THE DRAWINGS

FIG. 1 illustrates an optical network model of the present invention; and

FIG. 2 illustrates an average path duration of the present invention.

### DETAILED DESCRIPTION OF THE INVENTION

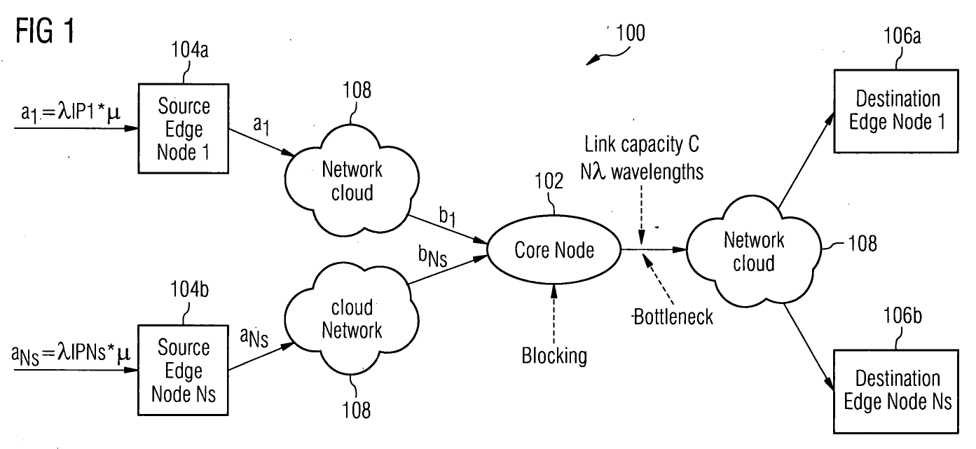

FIG. 1 illustrates the analytical model 100 of an OBS Network with non-negligible Setup Times that will be used to discuss the invention. In the figure, a core node 102, one or more edge nodes 104a, 104b, etc. (N_{S} sources), and destination nodes 106a, 106b, etc. are shown. These elements are connected through links and, possibly, networks 108 intervening. Problematically, a number of edge nodes sending traffic causes a bottleneck 110 at the core node 102. In order to manage this bottleneck 110, it is a first step to determine the average number of new setup requests (header packets) sent per second per wavelength λ_{λ} in OBS networks.

A total number of N_{S} sources 104a, 104b, etc. send information through a common core node 102. In particular, we focus on the traffic from the N_{S} sources 104a, 104b, etc. that is routed to the same output fiber at the core node 102, which we shall name as the bottleneck link (see FIG. 1). This output fiber has a capacity C and N_{λ} wavelengths of capacity C_{λ} each (C=N_{λ}*C_{λ}). The average IP packet arrival rate of each source i that is routed through the same output optical fiber at the core node 102 is represented by λ_{IPi}, and the average IP packet size by μ.

Each burst from each one of the N_{S} sources 104a, 104b, etc. is carried out by one of the N_{λ} available wavelengths of the output fiber. The mapping between wavelengths and bursts is done according to a wavelength assignment or wavelength scheduling algorithm, which selects the wavelength on which a burst is going to be sent according to some performance criteria. When using such algorithms it can be generally assumed that the load of the N_{S} traffic sources is equally distributed among the N_{λ} wavelengths of capacity C_{λ}. We proceed now to study the output fiber of the core node 102 as drawn in FIG. 1.

Due to the non-negligible setup times, not all of the capacity from a wavelength of an optical fiber connected at the ingress of the core node 102 in FIG. 1 can be used in order to transfer information. The effective wavelength capacity accurately describes the wavelength capacity that can be entirely used for data transmission. The capacity for the output optical fiber at the core node 102 in FIG. 1 will be calculated according to the invention as follows.

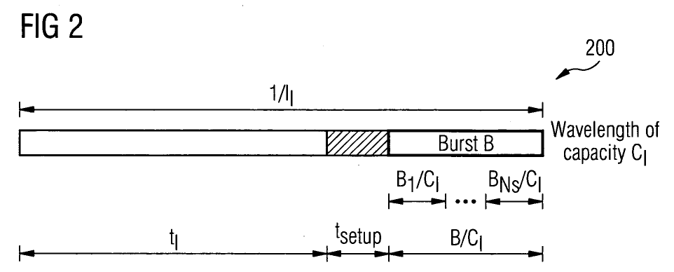

In OBS networks, the average inter-arrival time 200 between consecutive bursts on one of the N_{λ} wavelengths is equal to 1/λ_{λ}, where λ_{λ} is the average burst arrival rate per wavelength, and also the average number of setup requests (header packets) sent per second. This will be best understood from FIG. 2 that illustrates the average path duration. The average time 1/λ_{λ} is filled with the transmission of a burst B (that lasts B/C_{λ} seconds in a wavelength of capacity C_{λ}), and with the setup for the next burst. The parameter N_{λ} represents the number of sources sending information through the wavelength.

It shall be appreciated that, if a wavelength scheduling algorithm is being used, the burst arrival rate λ on an optical fiber with N_{λ} wavelengths can be calculated as the product N_{λ}*λ_{λ}, since λ_{λ} is the burst arrival rate per wavelength. This is given in Equation 1:
λ=λ_{λ}·N_{λ} equation 1

Moreover, the wavelength scheduling algorithm uniformly distributes the bursts of all sizes among all available wavelengths. This makes the average burst size B on a certain wavelength equal the average burst size on any other wavelength. Consequently we use no marker for the variable B since there is no distinction among wavelengths.

Since an edge node neither creates nor destroys information, the average IP packet throughput at its ingress λ_{IPi}*μ bps equals the average burst throughput at its egress λ*B, where λ_{IPi} is the average IP packet arrival rate of the packets aiming at the same output port of the core node 102 and μ is the average IP packet size. For an edge node 104a, 104b, etc. i we shall name its average IP packet throughput as aᵢ (see FIG. 1). On the other side, blocking may take place in an OBS network. For this reason, not all the throughput aᵢ from a certain traffic source i arrives at the core node 102 in FIG. 1. Bursts from each traffic source travel through a certain section of the OBS network denoted with the term “network cloud” in FIG. 1, and blocking may take place on each network cloud. Assume that the blocking probability in the network cloud traversed by bursts coming from edge node 104a, 104b, etc. i is Pbᵢ. It is clear then, that the average throughput bᵢ at the ingress of the core node 102 in FIG. 1 can be expressed as a function of the average throughput aᵢ at the egress of the edge node 104a, 104b, etc. i according to bᵢ=(1−Pbᵢ)*aᵢ=λ*B, where λ is the average burst arrival rate and B the average burst size.

Regardless of the aggregation strategy being used at the edge nodes, the probability that a burst in the bottleneck link comes from a given source i can be calculated based on the average arrival throughput (aiming at the same output port) of each traffic source bᵢ measured at the ingress of the core node 102 as set forth in Equation 2:

$${p}_{i} = \frac{{b}_{i}}{b} \qquad equation 2$$

where b is the total average throughput at the ingress of the core node 102 that is routed through the bottleneck link of equation 3:

$$b = {\sum }_{i = 1}^{{N}_{s}} {b}_{i} \qquad equation 3$$

This throughput is equally shared among the N_{λ} wavelengths, so that the average burst throughput per wavelength b_{λ} is equal to b_{λ}=b/N_{λ}.

Based on the concept of pᵢ, the average burst size B can be broken down into Bᵢ with the help of the probabilities pᵢ calculated in Equation 4 as follows:

$$B = {\sum }_{i = 1}^{{N}_{s}} {p}_{i} \cdot {B}_{i} \qquad equation 4$$

That is, the average burst size is the average burst size of the source 1 with a probability p₁, of the source 2 with a probability p₂ and so on. The average burst of each edge node 104a, 104b, etc. Bᵢ can be calculated according to its particular aggregation strategy.

According to this, the throughput b_{λ} per wavelength in the bottleneck (FIG. 1) can be formulated according to Equation 5 as:
b_{λ}=λ_{λ}·B equation 5

Where λ_{λ} is the average number of setup requests (or header packets) sent per second per wavelength. This rate can be expressed as a function of the input parameters as given by Equation 6:

$${λ}_{λ} = \frac{{\sum }_{i = 1}^{{N}_{s}} {λ}_{{IP}_{i}} \cdot μ}{{N}_{λ} \cdot B} \qquad equation 6$$

Where B is given by equation 4.

Note that with the help of equation 1 the average burst arrival rate in the whole optical fiber can be also calculated from λ_{λ} in equation 6.

In average we have that λ_{λ} bursts per second per end-to-end path (see FIG. 2) are sent in an OBS network. With each burst a reconfiguration of the optical switches is assumed, and therefore we have λ_{λ} new setups per second in average. For each path request tₛₑₜᵤₚ seconds are needed in order for the network to configure its optical routers. This sets an upper limit for the effective wavelength capacity BW_{λ} available for the transmission of information. Of the wavelength capacity C_{λ}, each time a new path setup takes place, C_{λ}*tₛₑₜᵤₚ bits of the capacity are wasted, so indeed C_{λ}*tₛₑₜᵤₚ*λ_{λ} bps of the capacity are wasted:

$${BW}_{λ} = {C}_{λ} \cdot ⌊ 1 - {t}_{setup} \cdot {λ}_{λ} ⌋ \qquad equation 7$$

The same goes for the rest of the wavelengths in the fiber. For each one the average number of new path setups per second λ_{λ} can be calculated, and with the setup time the effective wavelength capacity can be calculated. The capacity of the fiber can be calculated adding the effective bandwidth capacities of each wavelength of the fiber.

Now, the Effective Wavelength Utilization and the Effective Link Utilization can be calculated. The average wavelength utilization in the bottleneck link of an end-to-end- path of an OBS network is defined as the average burst throughput on a certain wavelength divided by the wavelength capacity as given by Equation 8.

$${ρ}_{OBS} = \frac{bps sent as bursts}{{C}_{λ}} = \frac{{λ}_{λ} \cdot B}{{C}_{λ}} \qquad equation 8$$

Where the average burst arrival rate λ_{λ} is given by equation 6, B is the average burst size (equation 4) and C_{λ} the wavelength capacity.

We must now readapt the definition of the average wavelength utilization given by equation 8 to the discussion of the effective wavelength capacity from the section above. Since from the wavelength capacity C_{λ} only a fraction BW_{λ} can be used due to the setup times, the average of the effective wavelength utilization ρ_{λ} is given by:

$${ρ}_{λ} = \frac{bps sent as bursts}{{BW}_{λ}} = \frac{{λ}_{λ} \cdot B}{{BW}_{λ}} = \frac{1}{{C}_{λ} \cdot {N}_{λ} \cdot [ \frac{1}{b} - \frac{{t}_{setup}}{B} ]} \qquad equation 9$$

Where b is given in equation 3 and B in equation 4 as a function of the input parameters.

The effective link utilization ρ is defined as the proportion of bandwidth of a certain optical fiber which can be used for the transmission of information. This can be obtained by considering the amount of burst traffic offered to the link divided by the effective link capacity. The effective link capacity is the addition of the effective wavelength capacities of the wavelengths present in the fiber. If N_{S} and N_{λ} are respectively the number of traffic sources and the number of wavelengths in the fiber, the effective bandwidth utilization is defined in Equation 10 as:

$$ρ = \frac{λ \cdot B}{{\sum }_{i = 1}^{{N}_{λ}} {BW}_{{λ}_{i}}} \qquad equation 10$$

Where λ is the average burst arrival rate for the whole optical fiber and is given by equation 1, and B is the average burst size on any given wavelength. If a wavelength scheduling algorithm is equally distributing the load among the different wavelengths, equation 10 and equation 9 are equal. When the effective link utilization is 1, the effective link capacity is loaded up to 100%, and the network reaches saturation.

The existence of a non-negligible setup time increases the blocking probability and thus reduces the network throughput. With the help of the analytical model described we provide a general method in order to quantify this effect to calculate the blocking probability.

Assume there are N_{S} edge nodes 104a, 104b, etc. sending traffic through a certain link (the bottleneck link in FIG. 1). Assume moreover that for a certain link load ρ, a certain number of wavelengths per link N_{λ} and certain traffic parameters γ₁, . . . , γₙ (e.g. variance, Hurst parameter).

The existence of non-negligible setup times increases the link load parameter ρ according to equation 9 and equation 10. We shall denote by ρ_{λ} the modified link load parameter.

Assume that the bursts from each traffic source i (i.e. edge node 104a, 104b, etc.) have a different average setup time which we denote as tᵢ. The probability pᵢ that a burst at the bottleneck link was sent by the edge node 104a, 104b, etc. i is given by equation 2. According to this we can calculate the average setup time in the bottleneck link tₛₑₜᵤₚ as follows:

$${t}_{setup} = {\sum }_{i = 1}^{{N}_{s}} {p}_{i} \cdot {t}_{i} \qquad equation 11$$

Thus, based on the foregoing calculated parameters, the blocking probability can be calculated using the known blocking formulae. It is according the to the instant invention recommended to select a blocking formula P based on the parameters calculated herein (ρ, N_{λ}, γ₁, . . . , γₙ).

A general method for calculating the blocking probability in an OBS network will now be set forth. The method begins by taking into account the average traffic throughput generated from the edge nodes that goes through the first optical core node 102. With this information we calculate the blocking probability Pbᵢ for each output fiber i of the core node 102 according to the steps presented below. With the blocking probability we calculate the average traffic throughput that goes to the next core node according to bᵢ=(1−Pbᵢ)*aᵢ, where aᵢ is the average incoming throughput that is offered to the output fiber i and bᵢ is the average outgoing throughput that is really sent through the output fiber i. With this information the blocking probability for each output fiber of the next core node 102 according to the steps presented below, and so on, is calculated.

First, let N_{S} edge nodes send each a burst throughput of bᵢ=λ_{IPi}*μ*(1−Pbᵢ) bps through a certain output fiber of capacity C_{λ} and N_{λ} wavelengths, where λ_{Ipi}*μ is the throughput at the IP level, and Pbᵢ is the blocking probability calculated so far from the edge node to the core node 102. The average burst size of the bursts generated by edge node 104a, 104b, etc. i is Bᵢ and it can be calculated depending on the corresponding aggregation strategy. Second, the total average throughput b at the ingress of the core node 102 that is routed through the bottleneck link according to equation 3 is calculated. Third, the probability pᵢ that a burst in the bottleneck link comes from a given source i according to equation 2 is calculated. Fourth, the average burst size B in the bottleneck link according to equation 4 is calculated. Fifth, the average setup time tₛₑₜᵤₚ from the N_{S} traffic sources according to equation 11 is calculated. Sixth, the average (effective) wavelength utilization factor PA according to equation 9 is calculated. Finally, this utilization factor is used in the blocking formula P(ρ_{λ}, N_{λ}, γ₁, . . . , γₙ) and used to calculate the blocking probability in the bottleneck link Pⱼ.

The present invention is advantageous as It is an exact method since no approximations of any kind where made. Another advantage is that the invention is valid for any kind of traffic statistics (e.g. poisson traffic, self-similar traffic). This allows the model to be used in Access as well as in Core Networks. The invention is also easy to implement and to calculate. This makes it suitable for its implementation in OBS edge nodes, OBS core nodes or in planing tools. Additionally, the invention incorporates the notion of multimode optical fibers, allowing for multiple wavelengths in a fiber. The invention gives a clear and quantitative understanding of the factors than influence OBS's performance in terms of blocking probability and throughput. The invention is also compatible with any standard model that calculates the blocking probability in OBS networks and introduces a modification at the average link utilization calculation. With this modification, any method described in the literature can be used including automatically the effect of the non-negligible setup times.

Thus, the inventive develops a way to extend any blocking probability model in the literature for OBS networks in order to incorporate the important case where the setup times are non-negligible. The invention takes into account and quantifies the impact of the setup times on a series of important parameters and measures, such as, Network throughput, Burst arrival rate, Link load and Blocking probability.

1. A method for managing a data burst throughput of an Optical Burst Switching network, the method comprising:
determining a setup time based on a probability that a burst at a core node of the Optical Burst Switching network was sent by an edge node coupled to the core node;
determining an effective wavelength utilization based on the determined set up time;
determining a blocking probability for the core node based on the effective wavelength utilization that is determined; and
routing the data burst of the Optical Burst Switching network using the determined blocking probability.

2. The method according to claim 1, wherein the effective wavelength utilization (ρ_{λ}) is determined according to the following equation:
$${ρ}_{λ} = \frac{1}{{C}_{λ} \cdot {N}_{λ} \cdot [ \frac{1}{b} - \frac{{t}_{setup}}{B} ]}$$
wherein C_{λ} is the wavelength capacity of the core node, N_{λ} is the number of wavelengths of the core node, b is the total average throughput at an ingress of the core node, tₛₑₜᵤₚ is the average setup time corresponding to the edge node, and B is the average burst size of the core node.

3. The method according to claim 1, wherein the probability that a burst at the core node was sent by an edge node is based on a comparison between an average throughput at an ingress of the core node and a total average throughput at the ingress.

4. The method according to claim 1, wherein the setup time (tₛₑₜᵤₚ) is based on a summation of the probabilities (Pi) that a burst at the case node was sent by a particular edge node factored by respective average setup times (ti).

5. The method according to claim 1, wherein the blocking probability (P) is based on a certain number of wavelengths per link (N_{λ}) connecting edge nodes to the core node.

6. The method according to claim 1, wherein the set up time is an average setup time (tₛₑₜᵤₚ) related to a comparison of the setup time relative to an average burst size (B).

7. The method according to claim 6, wherein the effective wavelength utilization (ρ_{λ}) is related to an inverse of an average throughput (b) at an ingress of the core node less the comparison.

8. The method according to claim 1, wherein the effective wavelength utilization (ρ_{λ}) is a factor of a wavelength capacity (C_{λ}) of the core node.

9. The method according to claim 1, wherein the effective wavelength utilization (ρ_{λ}) is a factor at a number of wavelengths (N_{λ}) of the core node.

10. The method according to claim 1, further comprising determining an average throughput (b) at the ingress of the core node by summing an average arrival throughput of each edge node.

11. The method according to claim 10, wherein determining the average throughput (b) is determined from a summation of an average burst size (Bi) of each edge node factored by a probability (pi) that corresponding bursts originate from respective edge nodes.

12. The method according to claim 1, wherein determining a total average throughput (b) is based on a throughput (bi) of each edge node.

13. The method according to claim 12, wherein determining the total average throughput (bi) is based on a blocking probability (P_{bi}) between a respective edge node and the core node.

14. A system for managing a data burst throughput of an Optical Burst Switching network, comprising:
a core node of the Optical Burst Switching network; and
an edge node connected to the core node, wherein the core node is allocated a wavelength based on a blocking probability determined from at least a setup time of the edge node.

15. The system according to claim 14, wherein the setup time is determined from a probability (Pi) that a burst at a core node of the Optical Burst Switching network is sent by the edge node coupled to the core node.

16. The system according to claim 14, wherein the setup time is used to determine an effective wavelength utilization (ρ_{λ}) that is used to determine the blocking probability.

17. The system according to claim 15, wherein the setup time is used to determine an effective wavelength utilization (ρ_{λ}) that is used to determine the blocking probability.

18. The system according to claim 14, wherein the effective wavelength utilization (ρ_{λ}) is determined according to the following equation:
$${ρ}_{λ} = \frac{1}{{C}_{λ} \cdot {N}_{λ} \cdot [ \frac{1}{b} - \frac{{t}_{setup}}{B} ]}$$
wherein C_{λ} is the wavelength capacity of the core node, N_{λ} is the number of wavelengths of the core node, b is the total average throughput at an ingress of the core node, tₛₑₜᵤₚ is the average setup time corresponding to the edge node, and B is the average burst size of the core node.

19. The system according to claim 15, wherein the effective wavelength utilization (ρ_{λ}) is determined according to the following equation:
$${ρ}_{λ} = \frac{1}{{C}_{λ} \cdot {N}_{λ} \cdot [ \frac{1}{b} - \frac{{t}_{setup}}{B} ]}$$
wherein C_{λ} is the wavelength capacity of the core node, N_{λ} is the number of wavelengths of the core node, b is the total average throughput at an ingress of the core node, tₛₑₜᵤₚ is the average setup time corresponding to the edge node, and B is the average burst size of the core node.

20. The system according to claim 16, wherein the effective wavelength utilization (ρ_{λ}) is determined according to the following equation:
$${ρ}_{λ} = \frac{1}{{C}_{λ} \cdot {N}_{λ} \cdot [ \frac{1}{b} - \frac{{t}_{setup}}{B} ]}$$
wherein C_{λ} is the wavelength capacity of the core node, N_{λ} is the number of wavelengths of the core node, b is the total average throughput at an ingress of the core node, tₛₑₜᵤₚ is the average setup time corresponding to the edge node, and B is the average burst size of the core node.
